(19) United States
(12) Patent Application Publication
(10) Pub. No.: US 2012/0285983 A1
(43) Pub. Date: Nov. 15, 2012

(54) Anti-Static Haircare Towelette and Packaging and Method of Manufacture and Use

(76) Inventor: Roberta S. Ahlbrand, Westpoint, IN (US)

(21) Appl. No.: 13/470,770

(22) Filed: May 14, 2012

Related U.S. Application Data
(60) Provisional application No. 61/485,236, filed on May 12, 2011.

(51) Int. Cl. G07F 11/16; B65D 81/22; B65B 13/00

(52) U.S. Cl. 221/303; 206/205; 53/428

(57) ABSTRACT

An anti-static hair care product and packaging includes a towelette that is absorptive of hair conditioner and durable such that the towelette may be repeatedly wiped onto a person's hair. The towelette may be moistened with hair conditioner or dried after application thereof. One or more towelettes may be stored in a package. The towelette may be presented in a flattened condition or with multiple folds for packaging purposes. In some embodiments, individual towelettes may be pulled from the packaging through a slot. In other embodiments, the packaging may include a reservoir for holding an anti-static agent and a dispensing member, such as a pump, for selectively dispensing a quantity of the anti-static agent onto a towelette.

### REFERENCE TO RELATED APPLICATIONS

This application is a non-provisional patent application relating to provisional patent application Ser. No. 61/485,236 filed May 12, 2011 and titled Anti-Static Haircare Towelette and Packaging.

### BACKGROUND OF THE INVENTION

This invention relates generally to personal hair care products and, more particularly, to a towelette or tissue that is saturated with hair conditioner and which, upon application to a person's hair, reduces static electricity.

A person's hair is often filled with static electricity upon removing a hat, brushing one's hair, after sleeping or resting one's head upon a fabric surface, or simply due to weather conditions. It is often difficult to cause one's hair to lay down as intended so long as static electricity remains in the hair. Brushing or combing hair that is simply dry and tangled may also be frustrating and unsuccessful without first treating the hair in some way to remove the tangles.

Various products and proposals have been made in the prior art for overcoming static in a person's hair so as to simplify brushing or combing the hair. Hair conditioner is known to have anti-static electricity qualities. Although assumably effective for their intended purposes, the existing proposals do not provide a product that is portable so as to be easily carried by a user, stored in a purse or pocket, and enables a user to determine how much of a detangling or anti-static substance is applied to one's hair.

Therefore, it would be desirable to have anti-static haircare towelette and associated packaging that is essentially saturated in hair conditioner and that is suitable to apply to one's hair in order to reduce static electricity. Further, it would be desirable to have a static electricity reducing towelette that may be stored in packaging that is conveniently portable and storable in compact packaging.

### SUMMARY OF THE INVENTION

A static reducing towelette and packaging according to a preferred embodiment of the present invention includes a tissue that is absorptive of hair conditioner and durable such that the tissue may be repeatedly wiped onto a person's hair. The tissue itself may be wet with an abundance of hair conditioner or dried after application of hair conditioner. One or more towelettes may be stored in a package, such a plastic box, a box-shaped dispenser, or in flexible and resilient packaging such as a plastic covering. The towelette may be presented in a flattened condition or with multiple folds depending on the size constraints of the packaging. In some embodiments, individual towelettes may be pulled from the packaging through a port, i.e. a towelette may be selectively dispensed from a container. In other embodiments, the packaging may include a reservoir for holding hair conditioner or another anti-static agent and a dispensing agent, such as a pump, for selectively dispensing a quantity of the anti-static agent onto a wipe stored within the container.

Therefore, a general object of this invention is to provide a static reducing towelette and packaging for enabling a consumer to reduce static electricity in her hair.

Another object of this invention is to provide a static reducing towelette and packaging, as aforesaid, that is convenient for a consumer to carry, store, and use.

Still another object of this invention is to provide a static reducing towelette and packaging, as aforesaid, in which a towelette may be selectively moistened with a static reducing liquid immediately prior to use.

Yet another object of this invention is to provide a static reducing towelette and packaging, as aforesaid, in which packaging may hold multiple towelettes and dispense them individually.

A further object of this invention is to provide a static reducing towelette and packaging, as aforesaid, that is economical to manufacture.

Other objects and advantages of the present invention will become apparent from the following description taken in connection with the accompanying drawings, wherein is set forth by way of illustration and example, embodiments of this invention.

### BRIEF DESCRIPTION OF THE DRAWINGS

FIG. 1 is a perspective view of packaging containing one or more static reducing towelettes according to a preferred embodiment of the present invention;

FIG. 2 is another perspective view of the packaging shown in FIG. 1 with one static reducing towelette removed therefrom;

FIG. 3 is another perspective view of the packaging shown in FIG. 1 with the lid in a closed configuration;

FIG. 4 is a perspective view of the packaging from another angle showing a reservoir of anti-static fluid; and

FIG. 5 is a perspective view of packaging according to another embodiment of the present invention having a dispenser slot.

### DESCRIPTION OF THE PREFERRED EMBODIMENT

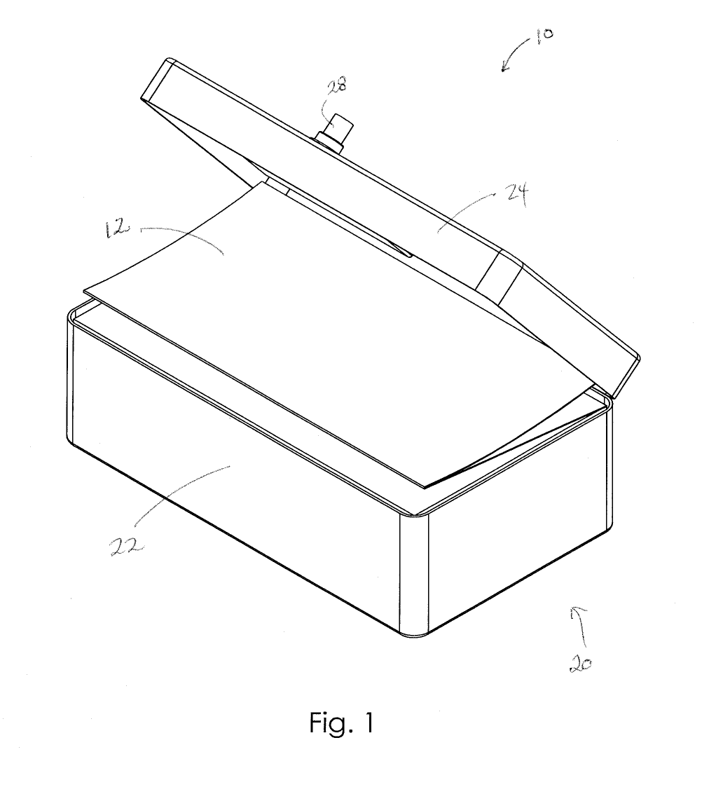

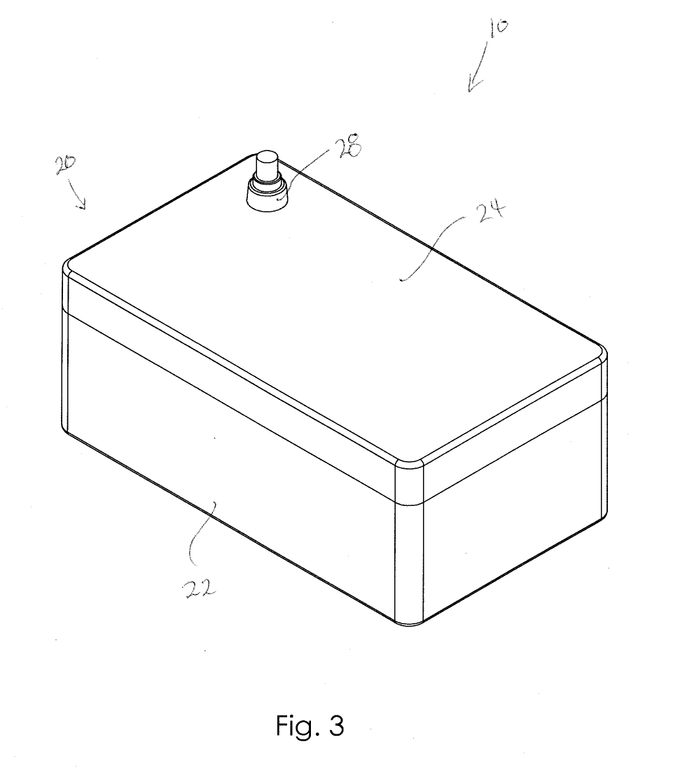

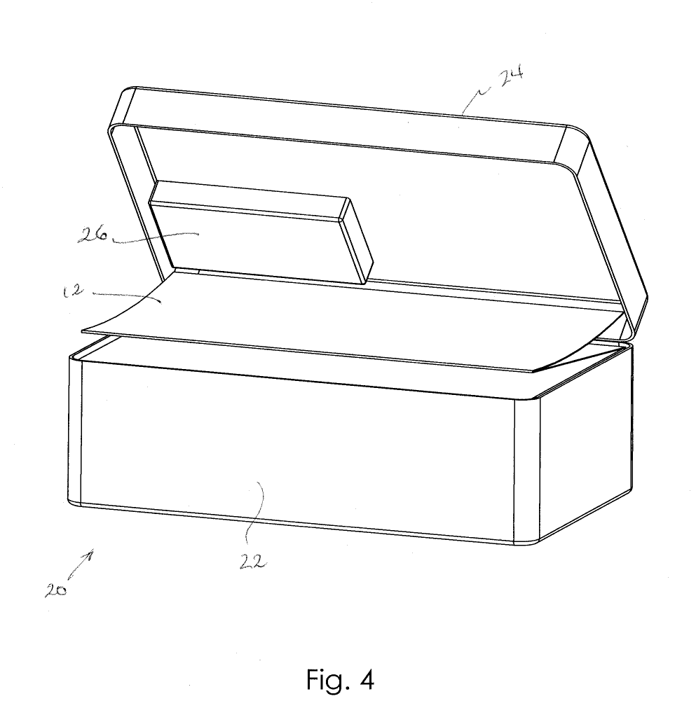

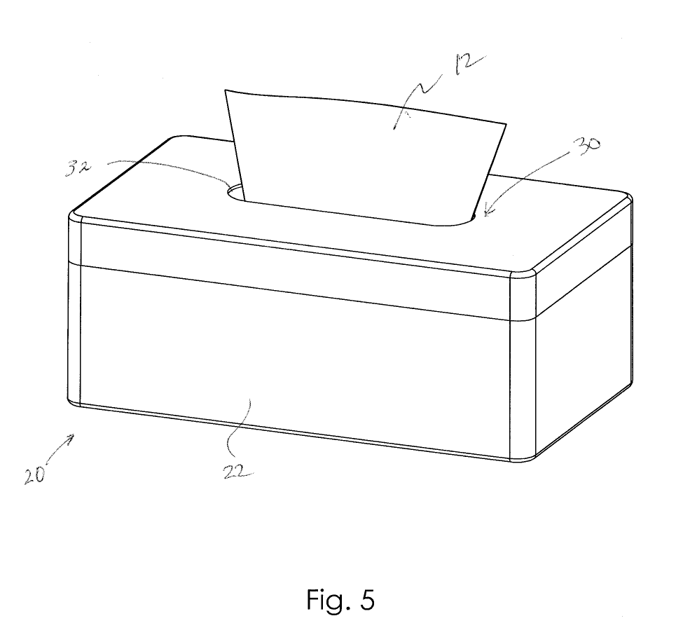

An anti-static electricity towelette and packaging for containing the towelettes according to the present invention will now be described with specific reference to FIGS. 1 to 5 of the accompanying drawings.

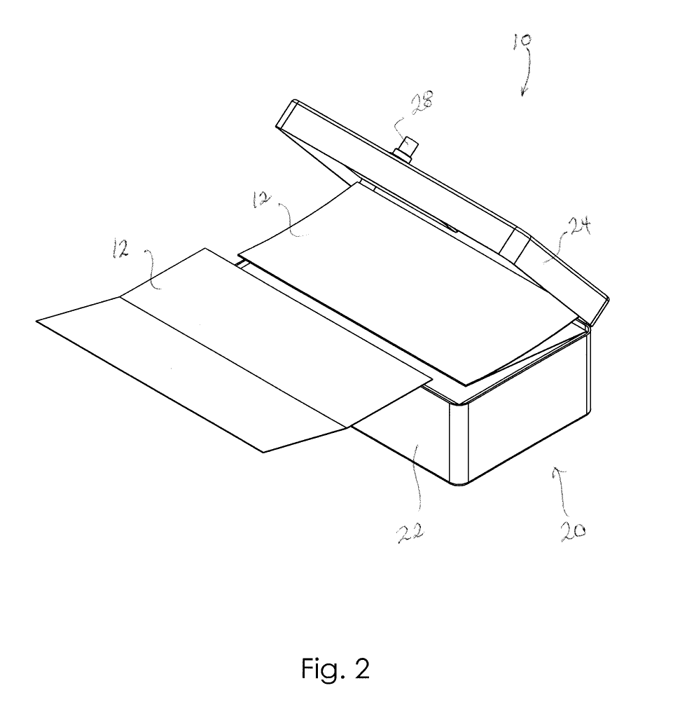

An anti-static electricity and packaging product 10 includes at least one flexible towelette 12 although it is understood that a plurality of towelettes 12 may be packaged together as described below and shown in the figures. Although the towelette 12 shown in FIG. 2 is at least foldable about a center longitudinal axis, it is understood that each towelette 12 may be folded multiple times, both lengthwise and widthwise so as to be configured in a very compact manner. If folded multiple times so as to have a small geometric area, the folded towelette may be situated in a small package as will be described further later. Each fold may be referred to as a “fold line” or a “line of weakness.”

Preferably, each towelette may be saturated with an anti-static electricity liquid, such as hair conditioner. Hair conditioner of a type typically applied to a person's hair while bathing is known to cut down on the static electricity that may otherwise form in a person's hair. It is understood that other liquids with anti-static properties may also be applied to each towelette 12. The anti-static liquid may be applied at the point of manufacture and allowed to dry. In use, a dry towelette may be wiped on a user's hair and such application may still be effective to decrease static electricity. Alternatively, a moistened or saturated towelette may be applied to one's hair to provide better coverage and also to leave more evidence of complete application.

The present invention includes packaging 20 for the towelettes described above. It is understood that the packaging 20 may be larger or smaller than the packaging shown in the drawings. Further, the packaging 20 may be rigid, such as a hard plastic container or flexible, such as a thin and flexible plastic wrapper. As shown in the figures, the packaging 20 may include a box-like container 22 having a generally rectangular configuration having a bottom, upstanding side walls, and a lid 24 that defines an interior area. The interior area includes dimensions complementary to those of a plurality of towelettes 12 arranged one atop another in a stacked configuration (FIGS. 1 and 2). One or more towelettes 12 may be removed from the interior space when the lid 24 is moved to the open configuration (FIG. 2).

In some embodiments, a reservoir 26 may be positioned on an interior surface of the container lid 24 and filled, and later re-filled, with hair conditioner or other anti-static liquid. The container 22 may include a dispenser such as a pump 28 operatively configured to either spray liquid from the reservoir 26 through an upper end of the pump 28 onto a towelette 12 outside the container 22 or through an outlet (not shown) in the reservoir 26 onto the towelettes within the container 22. In this way, a user may prepare a towelette 12 to have more or less hair conditioner depending on an amount of static electricity in the user's hair to be neutralized, decreased, or minimized.

In another embodiment, the container 22 may include a towelette dispensing assembly 30. More particularly, a top surface of the lid 24 may define a slot 32 through which a towelette 12 may be partially extended until needed. Then, the extended towelette 12 may be pulled through the slot 32 and applied to hair to reduce static electricity.

A method for manufacturing or for otherwise preparing the towelettes for use, the towlettes described above may include saturating the towelettes with an anti-static electricity liquid such as hair conditioner. The method may then include the step of inserting the saturated towelettes into the interior area of the packaging in a stacked arrangement, whether the packaging s a rigid container or flexible plastic wrapper. In some embodiments, the method may include drying the towelettes 12 before inserting them into the packaging. In embodiments having a reservoir 26 and dispenser 28, the method of use may include dispensing additional anti-static liquid outside of the container 22 (such as onto a previously removed towelette) or into the container interior area (such as onto the plurality of towelettes). This enables a user to have control over how much or how little anti-static liquid to use depending on climate or other conditions causing static electricity.

In use, a user may carry the container 22 in her purse. Alternatively, if the container 22 and towelettes are configured in a smaller size, a user may carry them in her pocket. When the user's hair becomes unruly due to static electricity, such as on a windy or humid day or after removing a hat, a single towelette moistened with hair conditioner or other anti-static substance may be removed from the packaging 20 and applied to the user's hair. Proper application of the towelette includes wiping the towelette repeatedly against areas of the user's hair that is exhibiting static electricity. The same areas may be wiped repeatedly if needed to neutralize the static. In some embodiments, a user may pump a quantity of hair conditioner onto a towelette, such as when the static electricity is particularly active.

It is understood that while certain forms of this invention have been illustrated and described, it is not limited thereto except insofar as such limitations are included in the following claims and allowable functional equivalents thereof.

1. An anti-static electricity towelette and packaging apparatus, comprises:
a container having a bottom, at least one side wall extending upwardly from said bottom that defines an interior area and an open top, said container including a lid coupled to an upper edge of said side wall and movable between a closed configuration preventing access to said interior area and an open configuration allowing access to said interior area; and
a plurality of flexible towelettes situated in said interior space of said container, each one of said towelettes defining a plurality of fold lines and being saturated with a liquid having anti-static electricity properties.

2. The anti-static electricity towelette and packaging apparatus as in claim 1, further comprising:
a reservoir positioned on an interior surface of said lid that is configured to hold a liquid having anti-static electricity properties; and
a dispenser coupled to said lid and operatively configured to transfer said anti-static electricity liquid onto said one of said towelettes.

3. The anti-static electricity towelette and packaging apparatus as in claim 2, wherein said dispenser is a pump dispenser positioned on an outer surface of said lid and in operative communication with said reservoir, said pump dispenser configured to transfer a predetermined amount of the anti-static electricity liquid from inside said reservoir to an area outside said container interior area.

4. The anti-static electricity towelette and packaging apparatus as in claim 2, wherein said dispenser is a pump dispenser positioned on an outer surface of said lid and in operative communication with said reservoir, said pump dispenser configured to transfer a predetermined amount of the anti-static electricity liquid from inside said reservoir into said container interior area.

5. The anti-static electricity towelette and packaging apparatus as in claim 2, wherein said lid defines a slot configured to selectively receive one of said plurality of towelettes, whereby said one of said plurality of towelettes is selectively removable from said container interior area through said slot when said lid is in said closed configuration.

6. The anti-static electricity towelette and packaging apparatus as in claim 5, wherein said bottom, said side wall, and said lid of said container are constructed of a rigid material.

7. The anti-static electricity towelette and packaging apparatus as in claim 1, wherein said bottom, said side wall, and said lid of said container are constructed of a flexible material.

8. The anti-static electricity towelette and packaging apparatus as in claim 7, wherein said container is a flexible plastic wrapper.

9. The anti-static electricity towelette and packaging apparatus as in claim 1, wherein said plurality of towelettes is situated one atop another in a stacked arrangement in said container interior area.

10. The anti-static electricity towelette and packaging apparatus as in claim 2, wherein said anti-static electricity liquid is hair conditioner.

11. A method for manufacturing and using an anti-static electricity towelette and packaging, comprising the steps of:
providing a container having a bottom, at least one side wall extending upwardly from said bottom that defines an interior area and an open top, said container including a lid coupled to an upper edge of said side wall and movable between a closed configuration preventing access to said interior area and an open configuration allowing access to said interior area;
providing a plurality of flexible towelettes;
saturating said plurality of towelettes with a liquid having anti-static electricity properties; and
inserting said saturated towelettes into said interior area of said container.

12. The method as in claim 11 further comprising draying said saturated towelettes before inserting said saturated towelettes into said interior area of said container.

13. The method as in claim 12, wherein said container includes:
a reservoir positioned on an interior surface of said lid that is configured to hold a liquid having anti-static electricity properties; and
a dispenser coupled to said lid and operatively configured to transfer said anti-static electricity liquid onto said one of said towelettes.

14. The method as in claim 13, further comprising the step of dispensing anti-static electricity liquid from said reservoir.

15. The method as in claim 14, wherein said dispenser is a pump dispenser positioned on an outer surface of said lid and in operative communication with said reservoir, said pump dispenser configured to transfer a predetermined amount of the anti-static electricity liquid from inside said reservoir to an area outside said container interior area.

16. The method as in claim 14, wherein said dispenser is a pump dispenser positioned on an outer surface of said lid and in operative communication with said reservoir, said pump dispenser configured to transfer a predetermined amount of the anti-static electricity liquid from inside said reservoir into said container interior area.

17. The method as in claim 11, wherein said lid defines a slot configured to selectively receive one of said plurality of towelettes, whereby said one of said plurality of towelettes is selectively removable from said container interior area through said slot.

18. The method as in claim 11, wherein said container is a flexible plastic wrapper.

19. The method as in claim 11, further comprising the step of positioning said plurality of towelettes one atop another in a stacked arrangement in said container interior area.

20. The method as in claim 11, wherein said anti-static electricity liquid is hair conditioner.
